(19) United States
(12) Patent Application Publication
(10) Pub. No.: US 2026/0357924 A1
(43) Pub. Date: Nov. 12, 2026

(54) Plumbing Concrete Grommet

(71) Applicant: James Citarella, Massapequa, NY (US)

(72) Inventor: James Citarella, Massapequa, NY (US)

(21) Appl. No.: 19/200,087

(22) Filed: May 6, 2025

(51) Int. Cl. F16L 1/10

(52) U.S. Cl. CPC F16L 1/10

(57) ABSTRACT

A plumbing accessory includes a cylindrical sleeve having an outer perimeter and an inner perimeter, an outer cylindrical balloon supported by the cylindrical sleeve outer perimeter and an inner cylindrical balloon supported by the cylindrical sleeve inner perimeter. The outer and the inner cylindrical balloons each have fill valves and in an embodiment have a shared fill valve.

### BACKGROUND

Significant problems are often associated with plumbing installations requiring the use of concrete structures at pre-wall fabrication, specifically, the task of achieving precise alignment of pipes before concrete is poured. This endeavor is fraught with difficulty, as even a slight misalignment can lead to the need for extensive and costly adjustments. Without a means to accommodate minor errors, plumbers must cut into the hardened concrete to reposition pipes, which involves chiseling, creating a time-consuming, labor-intensive, and a disruptive adjustment.

### SUMMARY OF THE INVENTION

A plumbing accessory includes a cylindrical sleeve having an outer perimeter and an inner perimeter, an outer cylindrical balloon supported by the cylindrical sleeve outer perimeter and an inner cylindrical balloon supported by the cylindrical sleeve inner perimeter. The outer and the inner cylindrical balloons each have fill valves and in an embodiment have a shared fill valve.

### BRIEF DESCRIPTION OF THE DRAWINGS

FIG. 1 is a top side perspective view of a plumbing concrete grommet for subterranean plumbing in accordance with an embodiment of the present disclosure.

FIG. 2 is a top side perspective view of a stand-alone plumbing concrete grommet in accordance with an embodiment of the present disclosure.

FIG. 3 is a top side perspective view of the stand-alone plumbing concrete grommet as a planter in accordance with an embodiment of the present disclosure.

FIG. 4 is a top view of the plumbing concrete grommet including the cylindrical sleeve and inner and outer cylindrical balloons in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

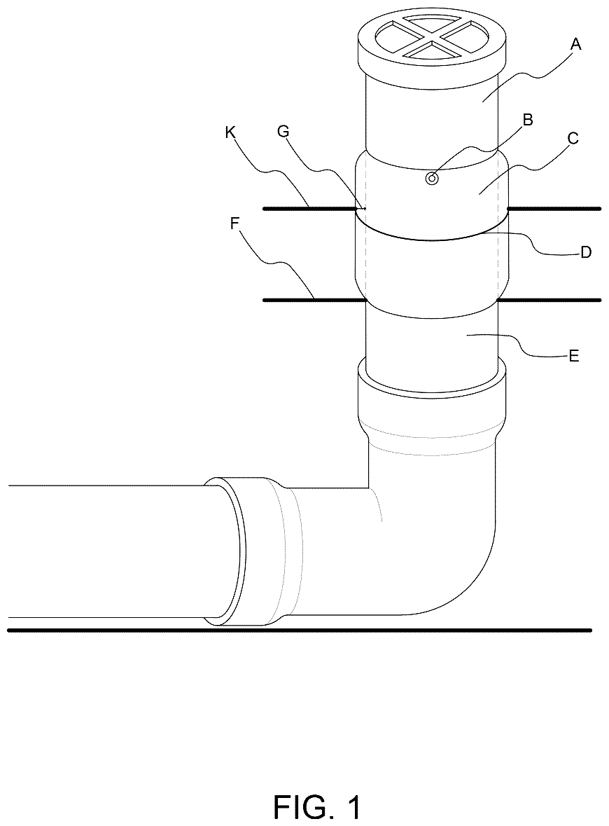

FIG. 1 is a top side perspective view of a plumbing concrete grommet for subterranean plumbing in accordance with an embodiment of the present disclosure. The view includes the above ground pipe or plumbing fitting A, the air valve B, the inflatable inner and outer cylindrical balloons C, the concrete slab level D, the underground pipe E, the ground level F, the clearance space G around the piping and the concrete K.

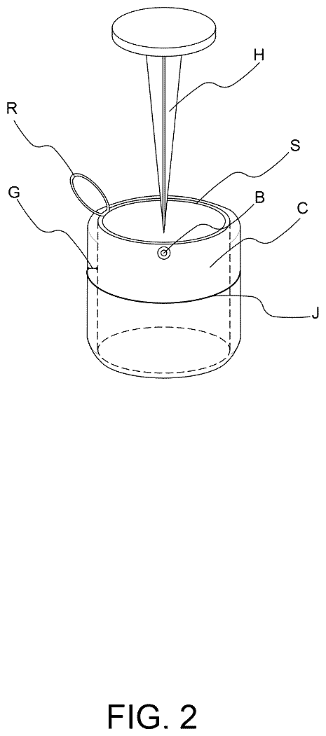

FIG. 2 is a top side perspective view of a stand-alone plumbing concrete grommet in accordance with an embodiment of the present disclosure. The view includes the inflatable inner and outer cylindrical balloons C, the fill valve B, the pull ring R, the clearance space G, the stake H, the soil/mulch level J and the cylindrical sleeve S.

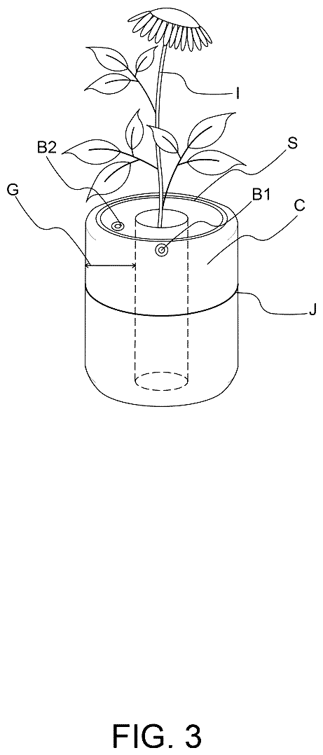

FIG. 3 is a top side perspective view of the stand-alone plumbing concrete grommet as a planter in accordance with an embodiment of the present disclosure. The view includes the inflatable inner and outer cylindrical balloons C, the respective fill valves B1 and B2, the clearance space G, the plant I, the soil/mulch level J and the cylindrical sleeve S.

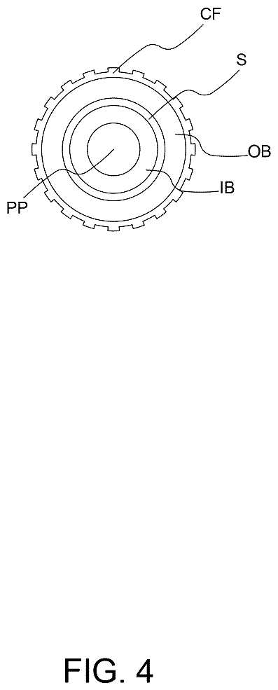

FIG. 4 is a top view of the plumbing concrete grommet including the cylindrical sleeve and inner and outer cylindrical balloons in accordance with an embodiment of the present disclosure. The view includes the plumbing pipe PP, the inner cylindrical balloon IB, the cylindrical sleeve S, the outer inflatable and cylindrical balloon OB, the cylindrical flutes CF imprinted longitudinally on an outer perimeter or diameter of the plumbing concrete grommet.

The disclosed plumbing concrete grommet simplifies and enhances the process of aligning plumbing pipes within concrete structures. The plumbing concrete grommet introduces an inflatable device that creates a customizable buffer around pipes, ensuring that there is adequate space to make minor adjustments without the need for intrusive concrete cutting.

By inflating around the pipe before the concrete is poured, this supportive accessory creates a void that remains once the concrete sets, allowing for easier and more accurate repositioning of the pipe, if needed. This design not only reduces the risk of misalignment but also minimizes the need for additional labor and the risk of material waste associated with correcting pipe placement issues.

Additionally, the disclosure can be manufactured as a reusable product, adding a sustainable aspect to its functionality that employs replaceable inserts, which minimizes environmental impact and lowers the long-term costs associated with disposable alternatives. The disclosure effectively streamlines the plumbing installation process, enhances precision, and reduces both the time and cost associated with construction adjustments requiring chopping cement after a cement wall or footing has been poured all while allowing for an eco-friendly construction practice.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A plumbing accessory comprising:
a cylindrical sleeve comprising an outer perimeter and an inner perimeter;
an outer cylindrical balloon supported by the cylindrical sleeve outer perimeter; an inner cylindrical balloon supported by the cylindrical sleeve inner perimeter; and
a fill valve for the outer cylindrical balloon and a fill valve for the inner cylindrical balloon.

2. The plumbing accessory of claim 1, wherein the outer cylindrical balloon further comprises chamfered ends.

3. The plumbing accessory of claim 2, wherein the inner cylindrical balloon further comprises chamfered ends.

4. The plumbing accessory of claim 1, wherein the outer cylindrical balloon and the inner cylindrical balloon comprise one balloon.

5. The plumbing accessory of claim 1, wherein the outer cylindrical balloon and the inner cylindrical balloons comprise two separate balloons.

6. The plumbing accessory of claim 1, wherein the cylindrical sleeve further comprises a puller ring.

7. The plumbing accessory of claim 1, wherein the cylindrical sleeve is configured to a plumbing diameter.

8. The plumbing accessory of claim 7, wherein the outer cylindrical balloon is configured larger than the plumbing diameter.

9. The plumbing accessory of claim 1, wherein the inner and the outer cylindrical balloons are filled with a liquid gel via respective fill valves.

10. The plumbing accessory of claim 1, wherein the respective fill valves each comprise a schrader valve configured to pass a fluid including air.

11. The plumbing accessory of claim 1, further comprising a skin of the outer and the inner cylindrical balloons embossed with longitudinal flutes.
